(19) United States
(12) Patent Application Publication
(10) Pub. No.: US 2018/0165767 A1
(43) Pub. Date: Jun. 14, 2018

(54) SYSTEM AND METHOD UTILIZING THRESHOLD PRIORITY VALUES FOR A RISK RELATIONSHIP MANAGEMENT PLATFORM

(71) Applicants: Sean P. Faherty, Suffield, CT (US); John R. McCamy, Nashville, TN (US); Kenneth S. Khanzadian, Cicero, NY (US)

(72) Inventors: Sean P. Faherty, Suffield, CT (US); John R. McCamy, Nashville, TN (US); Kenneth S. Khanzadian, Cicero, NY (US)

(21) Appl. No.: 15/377,066

(22) Filed: Dec. 13, 2016

(51) Int. Cl. G06Q 40/08; G06F 17/30; G06Q 10/06

(52) U.S. Cl. CPC G06Q 40/08; G06Q 10/063114; G06F 17/30371

(57) ABSTRACT

An assignment computer store may contain assignment manager identifiers, each linked to internal relationship handler identifiers (each in turn linked relationship identifiers). A risk relationship computer store may contain electronic data records each representing a risk relationship, with each electronic data record including a relationship identifier and a set of relationship characteristic values including a priority value). A risk relationship management platform may retrieve a selected electronic data record and determine that the priority value is above a minimum threshold and below a maximum threshold value. The selected relationship identifier may then be assigned one of the internal assignment manager identifiers and linked relationship handler identifier. A set of tasks may be generated along with a scheduled task date. A display at a relationship handler terminal associated with the assigned relationship handler identifier may then facilitate performance of the set of tasks in accordance with the associated scheduled task dates.

### BACKGROUND

In some cases, an enterprise might manage a substantial number of risk relationships with various entities. For example, an enterprise might have a number of internal assignment managers and relationship handlers that interact with entities to facilitate potential new risk relationships and/or existing risk relationship with the enterprise (e.g., a handler might interact with an entity and/or respond to events that arise in connection that entity). Note that different risk relationships might be associated with different priority values with respect to the enterprise (e.g., some risk relationships and/or entities might be assigned a higher priority as compared to other risk relationships and/or other entities). Moreover, different risk relationships might be established and/or different events might occur at different points and time and, as a result, various tasks associated with those relationships might need to be completed within different time periods. In some cases, an enterprise might assign one relationship handler to a relatively small number of entities and/or risk relationships (e.g., a single relationship handler might be assigned to three or four entities). Although this might let the handler respond to various events in an appropriate fashion (which can extend the duration of relationships between the entities and the enterprise), such an approach might not be practical in view of the priority values associated with those particular risk relationships. Further note that assigning too many risk relationships to a single handler could prevent that handler from responding to events in an accurate and efficient way—especially where there are a substantial number of relationships and/or events that are occurring at different points in time.

It would be desirable to provide systems and methods to accurately and efficiently facilitate processing of risk relationships for an enterprise, while allowing for flexibility and effectiveness when analyzing and/or assigning those relationships to handlers as appropriate.

### SUMMARY OF THE INVENTION

According to some embodiments, systems, methods, apparatus, computer program code and means are provided to accurately and efficiently facilitate processing of risk relationships for an enterprise. In some embodiments, an assignment computer store may contain assignment manager identifiers, each linked to internal relationship handler identifiers (each in turn linked relationship identifiers). A risk relationship computer store may contain electronic data records each representing a risk relationship, with each electronic data record including a relationship identifier and a set of relationship characteristic values including a priority value. A risk relationship management platform may retrieve a selected electronic data record and determine that the priority value is above a minimum threshold and below a maximum threshold value. The selected relationship identifier may then be assigned one of the internal assignment manager identifiers and linked relationship handler identifier. A set of tasks may be generated along with a scheduled task date. A display at a relationship handler terminal associated with the assigned relationship handler identifier may then facilitate performance of the set of tasks in accordance with the associated scheduled task dates.

Some embodiments comprise: means for managing an assignment computer store containing a set of internal assignment manager identifiers, each internal assignment manager identifier being linked to a plurality of internal relationship handler identifiers, and each internal relationship handler being linked to a plurality of relationship identifiers between the enterprise and entities; means for managing a risk relationship computer store containing a set of electronic data records each representing a risk relationship between the enterprise and an entity, each electronic data record including a relationship identifier and a set of relationship characteristic values with at least one characteristic value being a priority value for that risk relationship; means for retrieving, via an automated risk relationship management platform computer, a selected electronic data record from the risk relationship computer store; means for determining, by the automated risk relationship management platform computer, that the priority value of the risk relationship represented by the selected electronic data record is both above a pre-determined minimum threshold priority value and below a pre-determined maximum threshold priority value; responsive to said determination, means for arranging for the selected relationship identifier to be assigned to one of the internal assignment manager identifiers and linked relationship handler identifier in the assignment computer store; means for generating a set of tasks for the risk relationship associated with the selected electronic data record; means for calculating a scheduled task date for each automatically generated task; and means for exchanging electronic messages, via a distributed communication network, to present an interactive user interface at a remote relationship handler terminal associated with the assigned relationship handler identifier to facilitate performance of the generated set of tasks in accordance with the associated scheduled task dates.

In some embodiments, a communication device associated with a back-end application computer server exchanges information with remote devices. The information may be exchanged, for example, via public and/or proprietary communication networks.

Some technical effects of some embodiments of the invention are improved and computerized ways to accurately and efficiently facilitate processing of risk relationships for an enterprise. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system according to some embodiments.

FIG. 2 illustrates a method according to some embodiments of the present invention.

FIG. 3 illustrates a risk relationship management system for an insurer in accordance with some embodiments of the present invention.

FIGS. 4 through 8 illustrate a claims management workflow according to some embodiments.

FIGS. 8 through 12 illustrate a claims advisor workflow in accordance with some embodiments.

FIG. 13 illustrates a follow-up with underwriter display in accordance with some embodiments.

FIG. 14 illustrates a won opportunity tasks display according to some embodiments.

FIGS. 15 and 16 are associated with managing tasks displays in accordance with some embodiments.

FIG. 17 is a logging important touch points display according to some embodiments.

FIG. 18 is a block diagram of an apparatus in accordance with some embodiments of the present invention.

FIG. 19 is a portion of a tabular pricing prediction database in accordance with some embodiments.

FIG. 20 is an example of a claims advisor model according to some embodiments.

FIG. 21 illustrates a new business workflow in accordance with some embodiments.

FIG. 22 illustrates a sold business orientation contact workflow according to some embodiments.

FIG. 23 illustrates a post-effective date workflow in accordance with some embodiments.

FIG. 24 illustrates a pre-expiration date contact workflow according to some embodiments.

FIG. 25 illustrates a tablet computer displaying a risk relationship management platform user interface according to some embodiments.

FIG. 26 illustrates a system with a risk relationship management platform that shares data with other platforms in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access and/or accuracy of communications between devices by implementing a specific new method and system as defined herein. The present invention is a specific advancement in the area of one or more electronic data record management and assignment by providing benefits in data accuracy, data availability and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third party systems, networks and subsystems. For example, in the present invention information may be processed, managed, and/or assigned via a risk relationship management platform and results may then be analyzed accurately and used to automatically initiate workflows and/or establish communication links, thus improving the overall performance of the system associated with message storage requirements and/or bandwidth considerations (e.g., by improving the effectiveness and reducing the number of messages that need to be transmitted via a network and/or communication links). Moreover, embodiments might further improve performance values, response times, resource allocation decisions, etc.

In some cases, an enterprise might manage a substantial number of risk relationships with various entities. For example, an enterprise might have a number of internal assignment managers and relationship handlers that interact with entities. The handlers might, for example, help facilitate potential new risk relationships and/or existing risk relationship for the enterprise (e.g., a handler might interact with an entity and/or respond to events that arise in connection that entity). Note that different risk relationships might be associated with different priority values with respect to the enterprise (that is, some risk relationships and/or entities might be considered a higher priority as compared to other). In some cases, an enterprise might assign one relationship handler to only three or four entities and/or risk relationships. Although this might let the handler respond to various events in an appropriate fashion, such an approach might not be practical in view of the priority values associated with those relationships. Similarly, assigning too many risk relationships to a single handler could prevent the handler from responding to events in an accurate and efficient way.

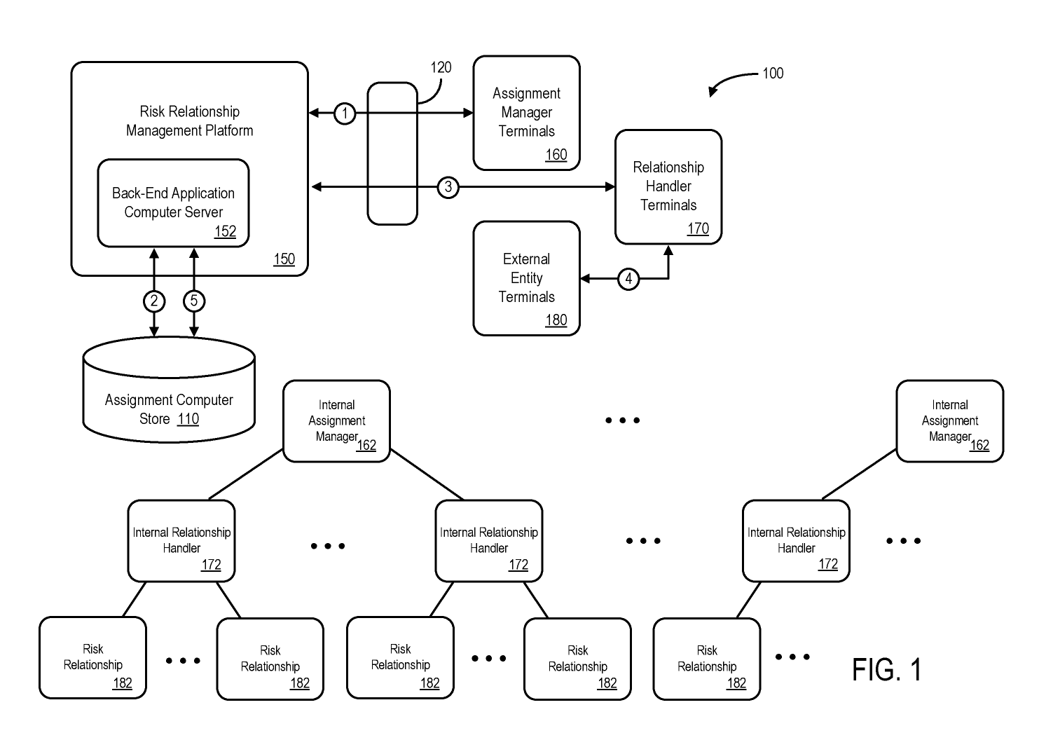

It would be desirable to provide systems and methods to accurately and efficiently facilitate processing of risk relationships for an enterprise, while allowing for flexibility and effectiveness when analyzing and/or assigning those relationships to handlers as appropriate. FIG. 1 is a high-level block diagram of a system 100 according to some embodiments of the present invention. In particular, the system 100 includes a risk relationship management platform 150 that may access information in an assignment computer store 110 (e.g., storing information about internal assignment managers 162, internal relationship handlers 172, risk relationships, etc.). The risk relationship management platform 150 may also exchange information with remote assignment management terminals 160 and/or relationship handler terminals 170 (e.g., via a firewall 120). According to some embodiments, a back-end application computer server 152 of the risk relationship management platform 150 may facilitate management, assignment, and viewing of information via one or more the terminals 160, 170. According to some embodiments, the risk relationship management platform 150 might be associated with a third party, such as a vendor that performs a service for an enterprise.

The risk relationship management platform 150 might be, for example, associated with a Personal Computer (“PC”), laptop computer, smartphone, an enterprise server, a server farm, and/or a database or similar storage devices. According to some embodiments, an “automated” risk relationship management platform 150 may facilitate the assignment of risk relationships based on electronic data records in the assignment computer store 110. As used herein, the term “automated” may refer to, for example, actions that can be performed with little (or no) intervention by a human.

As used herein, devices, including those associated with the risk relationship management platform 150 and any other device described herein may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The risk relationship management platform 150 may store information into and/or retrieve information from the assignment computer store 110. The assignment computer store 110 might, for example, store electronic records associated with a hierarchy wherein an internal assignment manager 162 might be linked to a number of different internal relationship handlers 172. Moreover, each relationship handler 172 might be linked to a number of different risk relationships 182. The assignment computer store 110 may be locally stored or reside remote from the risk relationship management platform 150. As will be described further below, the assignment computer store 110 may be used by the risk relationship management platform 150 to help manage and assign risk relationships. Although a single risk relationship management platform 150 is shown in FIG. 1, any number of such devices may be included. Moreover, various devices described herein might be combined according to embodiments of the present invention. For example, in some embodiments, the risk relationship management platform 150 and assignment computer store 110 might be co-located and/or may comprise a single apparatus.

According to some embodiments, the system 100 may automatically assign and manage risk relationships for an enterprise. For example, at (1) a manager at a manager terminal 160 might access the risk management platform 150 to determine if there are any new, unassigned risk relationships 182 (or currently assigned risk relationships that might be re-assigned). The back-end application computer server 152 may access the assignment computer store 110 at (2) to help determine this information. The manager might then assign (or re-assign) that risk relationship 182 and the information in the computer store 110 may be updated. Information about the newly assigned risk relationship 182 may be received by a relationship handler terminal 170 at (3), and he or she might take actions as appropriate, such as by establishing a communication link with an enteral entity terminal 180 at (4). Information about the various interactions associated with the risk relationship 182 (e.g., a time date of the interaction, a description of the interaction, etc.) may then be stored into assignment computer store 110 at (5).

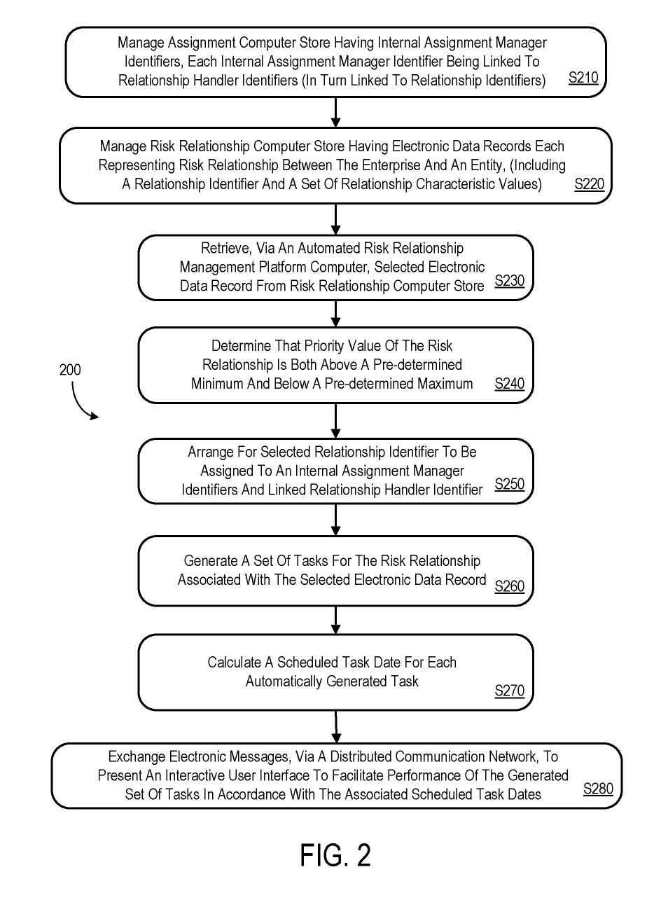

Note that the system 100 of FIG. 1 is provided only as an example, and embodiments may be associated with additional elements or components. According to some embodiments, the elements of the system 100 automatically facilitate the assignment and management of risk relationships. For example, FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may manage an assignment computer store containing a set of internal assignment manager identifiers, with each internal assignment manager identifier being linked to a plurality of internal relationship handler identifiers. According to some embodiments, each internal relationship handler is further linked to a plurality of relationship identifiers between the enterprise and entities. According to some embodiments, at least one risk relationship represents a potential future risk relationship between the enterprise and an entity. In some embodiments, at least one risk relationship represents an existing, ongoing risk relationship between the enterprise and an entity.

At S220, the system may manage a risk relationship computer store containing a set of electronic data records each representing a risk relationship between the enterprise and an entity. According to some embodiments, each electronic data record including a relationship identifier and a set of relationship characteristic values with at least one characteristic value being a priority value for that risk relationship;

At S230, an automated risk relationship management platform computer may retrieve a selected electronic data record from the risk relationship computer store. At S240, the automated risk relationship management platform computer may determine that the priority value of the risk relationship represented by the selected electronic data record is both above a pre-determined minimum threshold priority value and below a pre-determined maximum threshold priority value. That is, a risk relationship with a priority value above the pre-determined maximum threshold priority value might be handled by a different process (e.g., a single internal relationship handler might be assigned in such a situation). Similarly, a risk relationship with a priority value below the pre-determined minimum threshold priority value might be handled by a different process (e.g., no internal relationship handler might be assigned in such a situation).

Responsive to said determination, at S250 the system may arrange for the selected relationship identifier to be assigned to one of the internal assignment manager identifiers and linked relationship handler identifier in the assignment computer store. At S260, the system may generate a set of tasks for the risk relationship associated with the selected electronic data record. The tasks may, for example, facilitate the processing of events and other matters associated with the risk relationship. At S270, the system may calculate a scheduled task date for each automatically generated task (e.g., a time and date when the task should be initiated or completed). According to some embodiments, the system may assign the set of tasks to the assigned relationship handler, and the selected risk relationship may be associated with a potential inception date of the risk relationship and a potential expiration date of the risk relationship. The set of tasks might include, for example: (i) an initial opportunity contact task, (ii) a pro-active status task scheduled a first pre-determined period of time after the potential inception date, and/or (iii) a potential renewal task scheduled a second pre-determined period of time prior to the potential expiration date.

At S280, electronic messages may be exchanged via a distributed communication network to present an interactive user interface at a remote relationship handler terminal associated with the assigned relationship handler identifier. According to some embodiments, this may facilitate performance of the generated set of tasks in accordance with the associated scheduled task dates. According to some embodiments, the interactive user interface display at the remote relationship handler terminal automatically facilitates a communication link with a remote external entity terminal. For example, the automatically established communication link might be associated with a telephone call, a web chat, a video link, an electronic mail message, and/or a postal mail message generated via a distribution center.

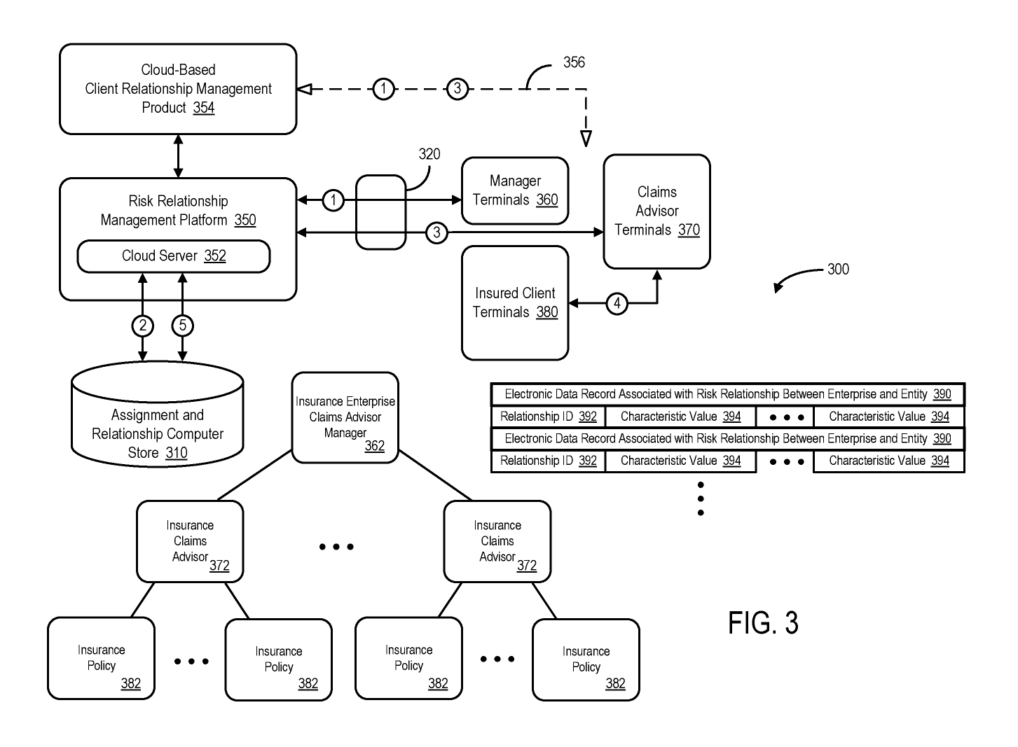

Embodiments of the present invention might be associated with a number of different types of “risk relationships.” As used herein, the phrase “risk relationship” might refer to, for example, an existing insurance policy between an insurer and an insured entity (e.g., whose policy is up for renewal) or potential insurance policy (e.g., associated with an entity who is considering purchasing insurance from the insurer). For example, FIG. 3 illustrates a risk relationship management system 300 for an insurer in accordance with some embodiments of the present invention. As before, the system 300 includes a risk relationship management platform 350 that may access information in an assignment and relationship computer store 310. For example, the assignment and relationship computer store 310 might store about insurance enterprise claims advisor managers 362, insurance claims advisors 372, and insurance policies 382. According to this embodiment, the assignment and relationship computer store 310 further stores a set of electronic data records each representing a risk relationship between the enterprise and an entity 390 (that is, an insurance policy between the insurer and an insured). Moreover, each electronic data record 390 includes a relationship identifier 392 (that is, an insurance policy identifier) and a set of relationship characteristic values 394 with at least one characteristic value being a premium value for that insurance policy.

The risk relationship management platform 350 may also exchange information with remote manager terminals 360 and/or claims advisor terminals 370 (e.g., via a firewall 320). According to some embodiments, a cloud server 352 of the risk relationship management platform 350 may facilitate management, assignment, and viewing of information via one or more the terminals 360, 370. According to some embodiments, the risk relationship management platform 350 might be associated with a third party, such as a vendor that performs a service for an enterprise.

As used herein, devices, including those associated with the risk relationship management platform 350 and any other device described herein may exchange information via any communication network which may be one or more of a LAN, a MAN, a WAN, a proprietary network, a PSTN, a WAP network, a Bluetooth network, a wireless LAN network, and/or an IP network. Note that any devices described herein may communicate via one or more such communication networks.

The risk relationship management platform 350 may store information into and/or retrieve information from the assignment and relationship computer store 310. The assignment and relationship computer store 310 might, for example, store electronic records associated with a hierarchy wherein an insurance enterprise claims advisor manager 362 might be linked to a number of different claims advisors 372. Moreover, claims advisor 372 might be linked to a number of different insurance policies 382. The assignment and relationship computer store 310 may be locally stored or reside remote from the risk relationship management platform 350. As will be described further below, the assignment and relationship computer store 310 may be used by the risk relationship management platform 350 to help manage and assign risk relationships. Although FIG. 3 illustrates each insurance policy 382 being linked to a single insurance claims advisor 372, according to some embodiments, a single insurance policy 382 might be linked to more than one insurance claims advisor 372 (e.g., and each of those might help interact with and respond to events in connection with that insurance policy 382).

According to some embodiments, the system 300 may automatically assign and manage risk relationships for an enterprise. For example, at (1) a manager at a manager terminal 360 might access the risk management platform 350 to determine if there are any new, unassigned insurance policies 382 (or currently assigned insurance policies that might be re-assigned). The cloud server 352 may access the assignment and relationship computer store 310 at (2) to help determine this information. The manager might then assign (or re-assign) that insurance policy 382 and the information in the computer store 310 may be updated. Information about the newly assigned insurance policy 382 may be received by a claims advisor terminal 370 at (3), and he or she might take actions as appropriate, such as by placing a telephone call to an insured client terminal 380 at (4). Information about the various interactions associated with the insurance policy 382 (e.g., a time date of the telephone call, a description of the telephone call, etc.) may then be stored into assignment and relationship computer store 310 at (5).

According to some embodiments, the risk relationship management platform 350 might communicate (e.g., with manager terminals 360 and/or claims advisor terminals 370 at (1) or (3)) via a cloud-based Client Relationship Management (“CRM”) product 354, such as a CRM product available from SALESFORCE.COM. As used herein, the phrase “CRM product” might refer to, for example, a product having an interface for case management and task management and/or a system that helps automatically route and process events (e.g., such as insurance policy sales opportunities).

According to some embodiments, the risk relationship management platform 350 might assign (or re-assign) insurance policies 382 to insurance claims advisors 372 based at least in part on a type of insurance (e.g., a workers' compensation insurance policy as compared to a business insurance policy), information from an insurance underwriter, a type of industry associated with the insured, an opportunity age, an opportunity likelihood of success (e.g., a high or low likelihood of eventually being converted into a sale), an entity priority (e.g., whether an entity is considered a Very Important Party (“VIP”) client), and/or an insurer office.

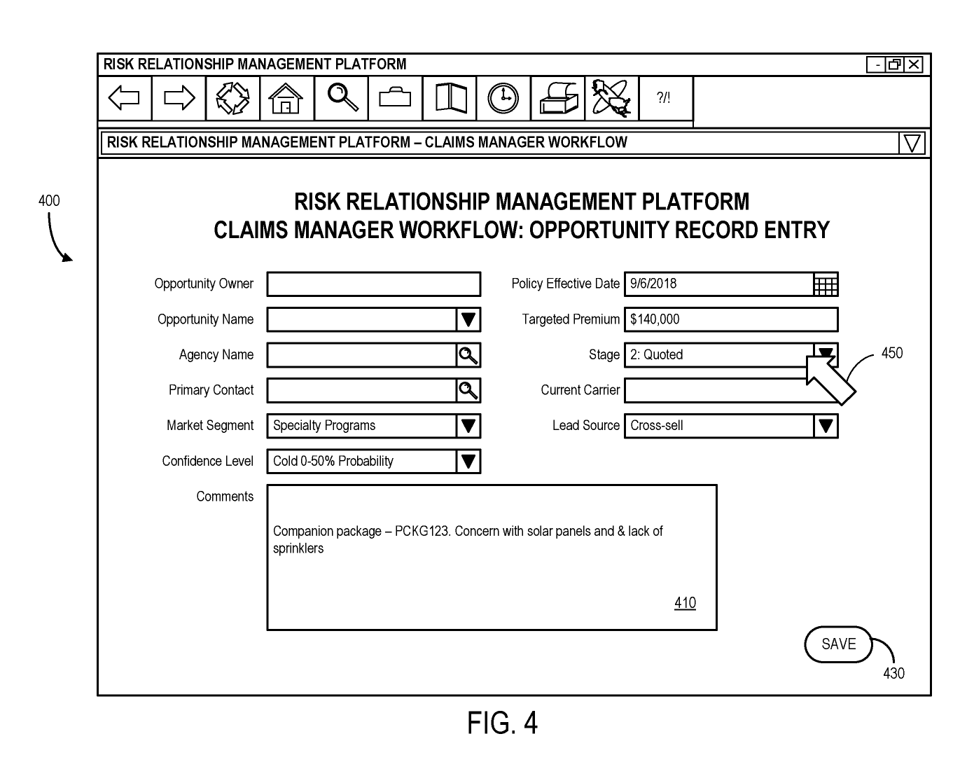

According to some embodiments, an interactive graphical user interface provided by the risk relationship management platform 350 includes a claims manager workflow, and FIGS. 4 through 8 illustrate a claims management workflow according to some embodiments. In particular, FIG. 4 illustrates a display 400 that might be provided when an opportunity record enters the claims process. The display 400 might include, for example, an opportunity owner, an opportunity name, an agency name, a primary contact, a market segment, a confidence level, comments 410, a policy effective date, a targeted premium value, a stage description, a current carrier, and/or a lead source. A manager might use a computer pointer 450 to enter a description of a stage (or to select a description of a stage from a drop-down menu), such as by indicating that an opportunity record has been quoted by selecting “2:Quoted” as illustrated in FIG. 4. The information in the display 400 might be saved by selection of a “Save” icon 430.

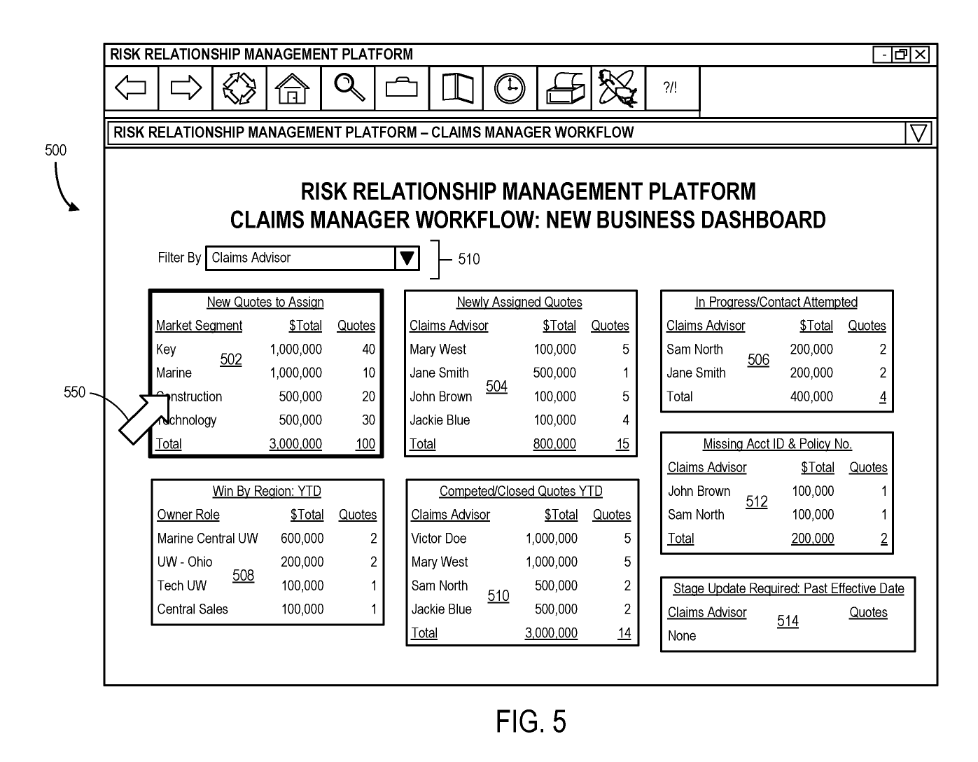

FIG. 5 illustrates a new business dashboard display 500 that might be filtered 510 by “Claims Advisor,” etc. in accordance with some embodiments. The display 500 might include, for example, a new quotes to assign portion 502 (e.g., including a market segment description, a total dollar amount, a number of quotes, etc.), a newly assigned quotes portion 504 (e.g., including a claims advisor name, a total dollar amount, a number of quotes, etc.), an in progress/contact attempted portion 506 (e.g., including a claims advisor name, a total dollar amount, a number of quotes, etc.), a win by region Year To Date (“YTD”) portion 508 (e.g., including an owner role description, a total dollar amount, a number of quotes, etc.), a completed/closed quotes YTD portion 510 (e.g., including claims advisor name, a total dollar amount, a number of quotes, etc.), a missing account number and insurance policy number portion 512 (e.g., including claims advisor name, a total dollar amount, a number of quotes, etc.), and/or a stage update required (past effective date) portion 514 (e.g., including a claims advisor name, a number of quotes, etc.).

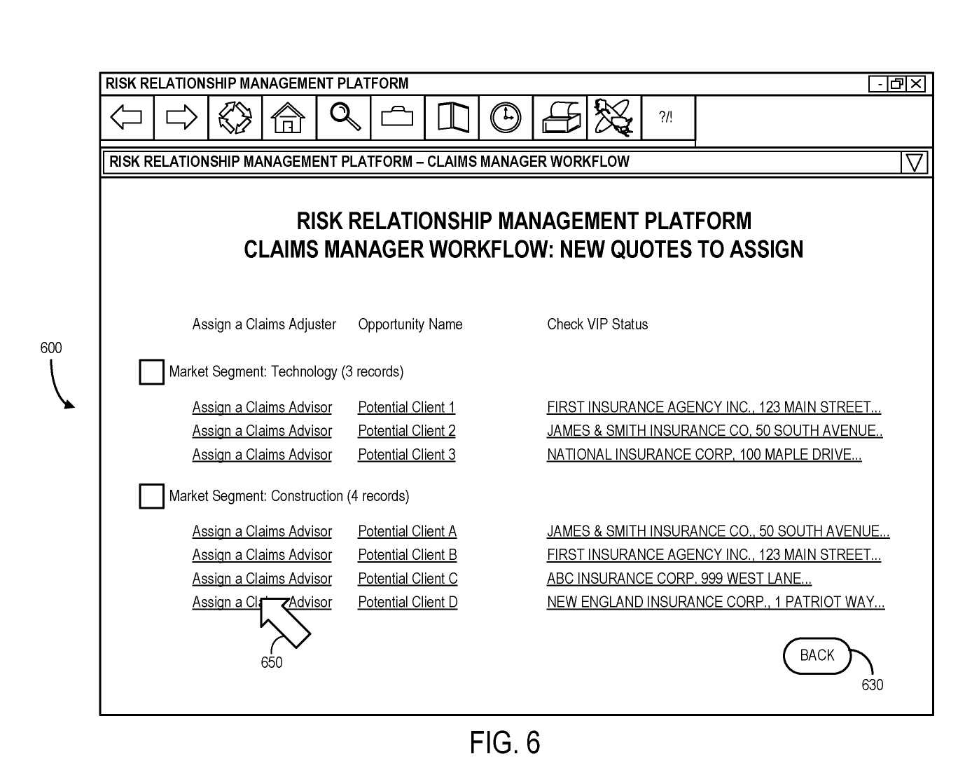

A manager might use a computer pointer 550 to select the “New Quotes to Assign” portion 502 as illustrated in FIG. 5. As a result of such a selection, FIG. 6 illustrates a new quotes to assign display 600 in accordance with some embodiments. The new quotes to assign display 600 may include, for example, an “assign to claims adjuster” link, an opportunity name, and a check VIP status for a number of records in various market segments. Selection of “Back” icon 630 might return the manager to a previous display.

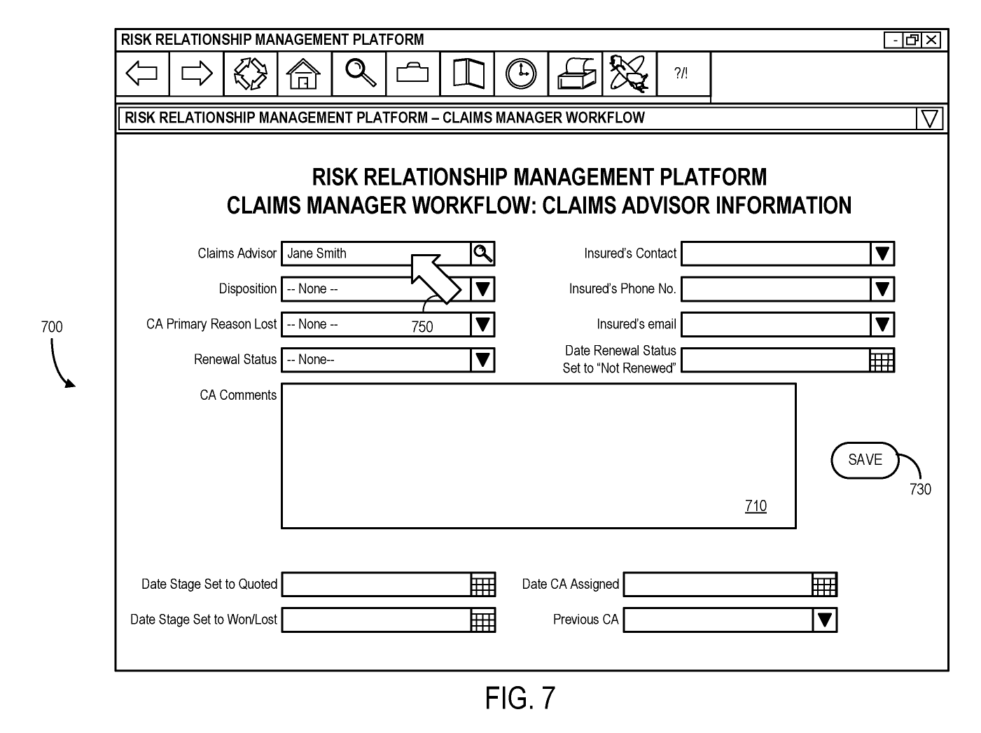

A manager might also use a computer pointer 650 to select an “assign claims adjuster” link. As a result of such a selection, FIG. 7 illustrates a claims advisor information display 700 in accordance with some embodiments. The display 700 might include, for example, a claims advisor, a disposition, a claims advisor primary reason lost, a renewal status, claims advisor comments 710, an insured's contact, a insured's phone number, an insured's email, a date a renewal status was set to “not renewed,” a date state was set to “quoted,” a date stage was set to “won/lost,” a date the claims advisor was assigned, and/or an a name of a previous claims advisor. The information in the display 700 might be saved by selection of a “Save” icon 730. A manager might use a computer pointer 750 to enter a claims advisor name (or to select a claims advisor from a drop-down menu) to assign that advisor to an opportunity.

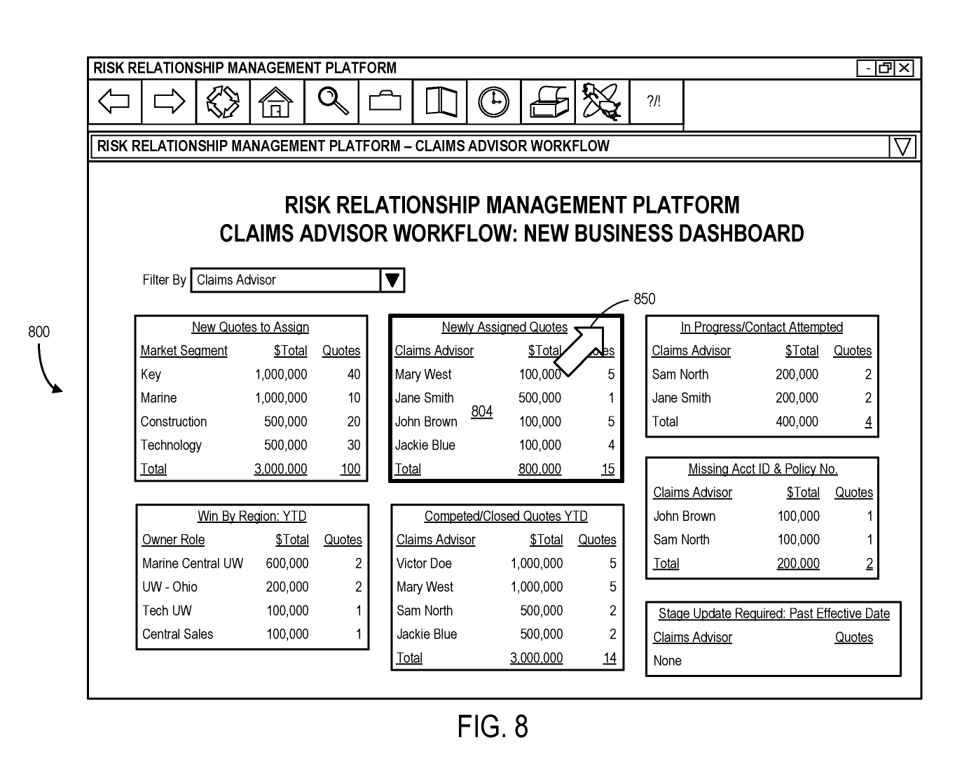

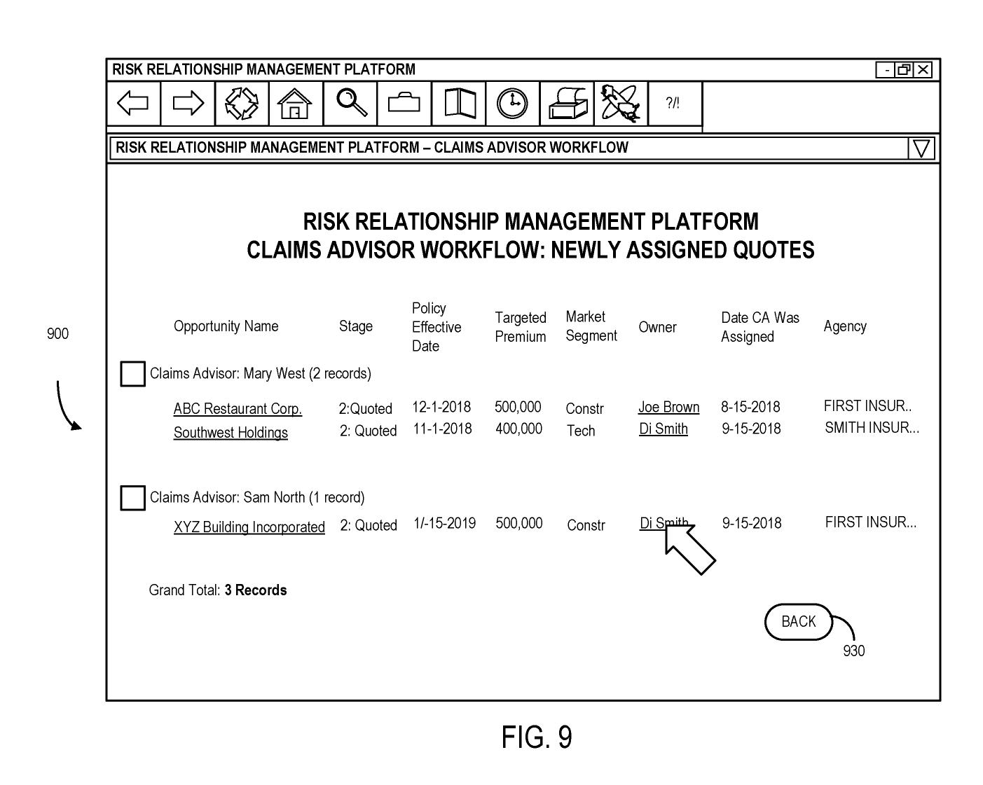

According to some embodiments, an interactive graphical user interface provided by the risk relationship management platform 350 includes a claims advisor workflow. FIGS. 8 through 12 illustrate a claims advisor workflow in accordance with some embodiments. In particular, FIG. 8 illustrates a new business dashboard display 800 that might be shown to a claims advisor in accordance with some embodiments. The claims advisor might use a computer pointer 850 to select “Newly Assigned Quotes.” As a result of such a selection, FIG. 9 illustrates a newly assigned quotes display 900 in accordance with some embodiments. The newly assigned quotes display 900 may include, for example, an opportunity name, an opportunity stage description, an insurance policy effective date, a targeted premium, an opportunity owner, a date the claims advisor was assigned, and/or an agency for a number of records associated with various claims advisors. Selection of “Back” icon 930 might return the claims advisor to a previous display.

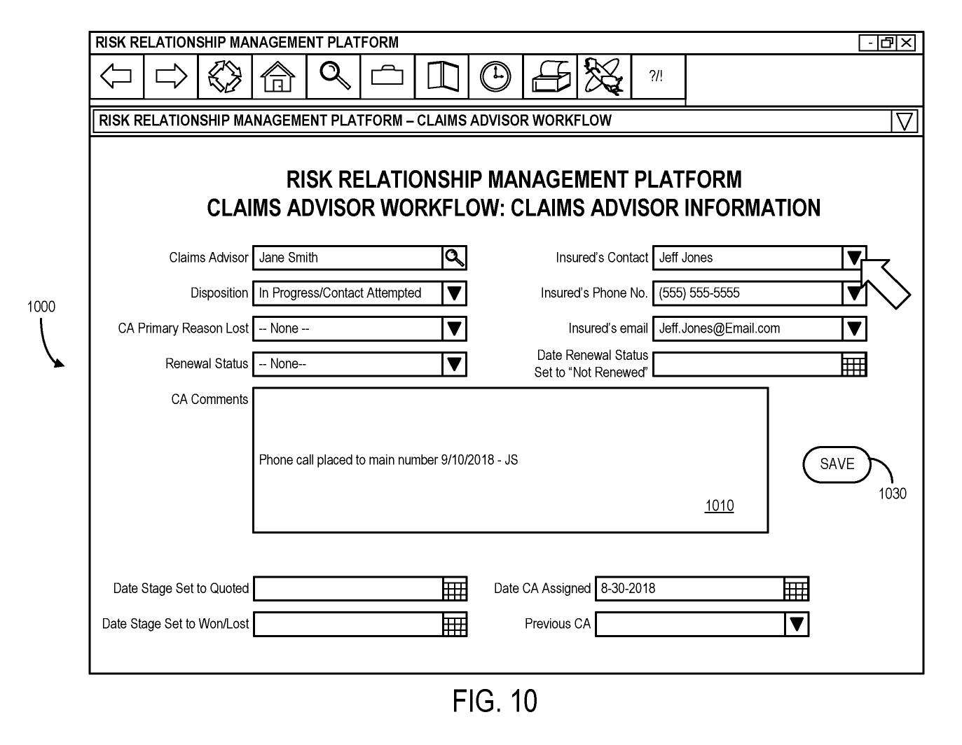

After the claims advisor speaks to an insurance underwriter, the appropriate insurance agency, and/or any other key players, he or she may enter information to a claims advisor information display 1000 such as the one illustrated in FIG. 10. For example, the claims advisor might select a new opportunity disposition (e.g., “in progress/contact attempted”), an insured's contact name, enter claims advisor comments 1010, etc. The information in the display 1000 might be saved by selection of a “Save” icon 1030.

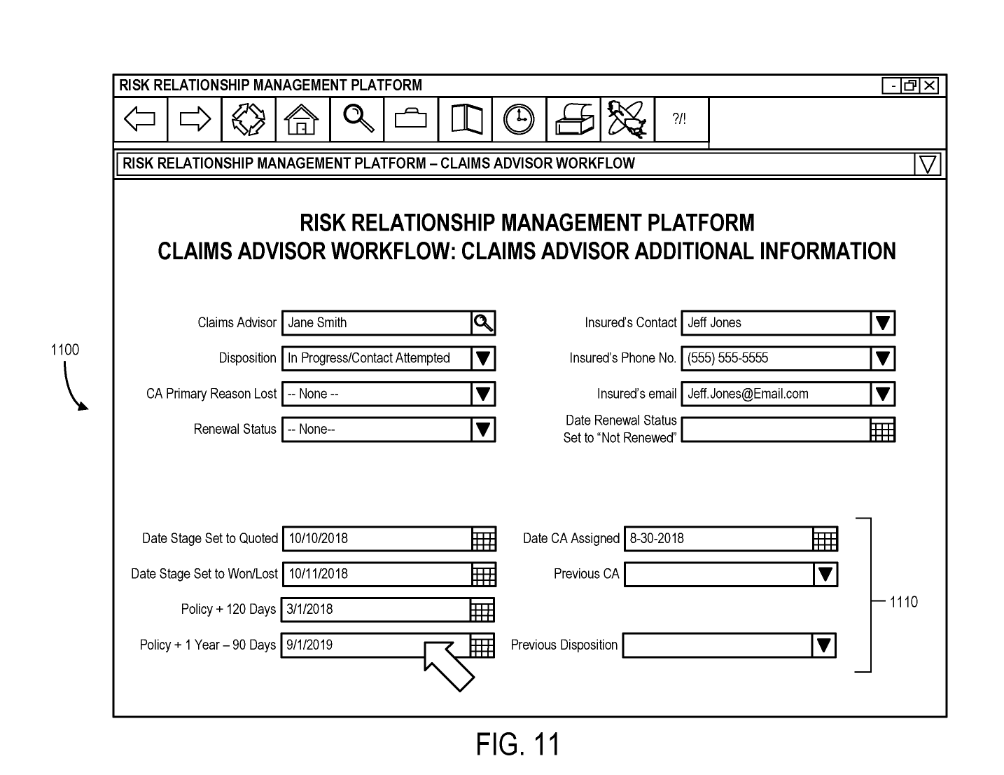

According to some embodiments, additional information might be automatically calculated and recorded by a cloud-based client relationship management product (e.g., associated with various tasks and/or dates when the tasks should be completed). For example, FIG. 11 illustrates claims advisor additional information display 1100 in accordance with some embodiments. The addition information display 1100 might include, for example, automatically populated fields 1110 associated with a date a stage was set to quoted, a date a stage was set to won/lost, a policy plus 120 days date, a policy plus 1 year less 90 days date, a date a claims advisor was assigned, a name of a previous claims advisor, a previous disposition, etc.

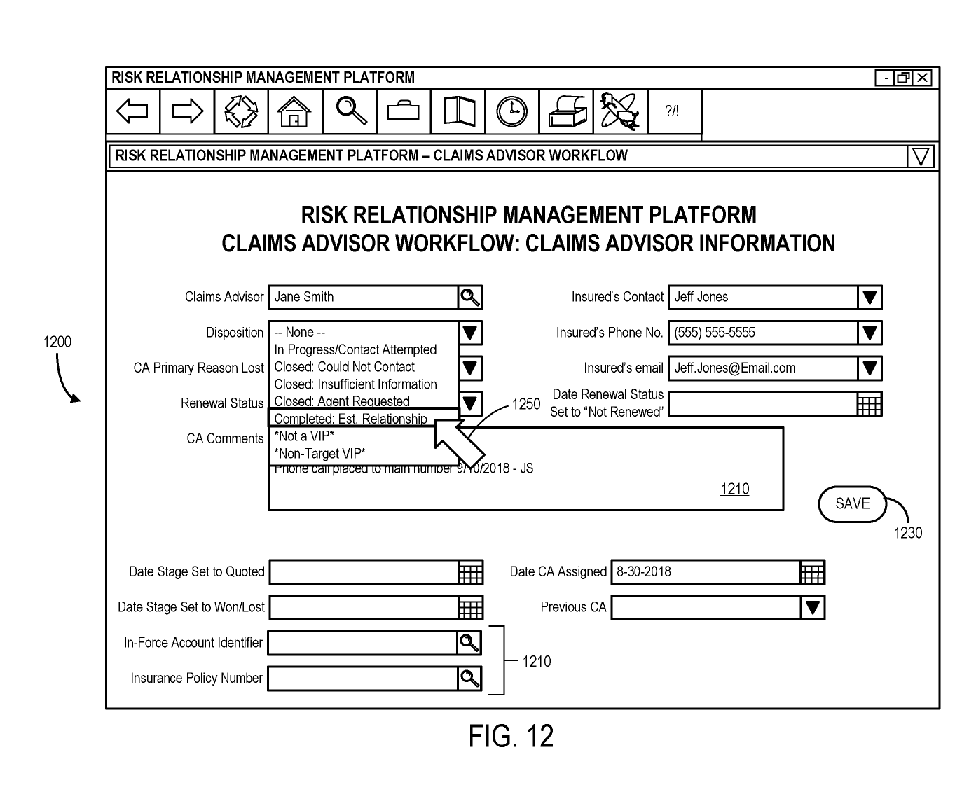

As illustrated in the display 1200 of FIG. 12, a goal of a claims advisor might be to establish a relationship with an insured's primary contact and use a computer pointer 1250 to select “Completed: Established Relationship” in a disposition drop-down menu. If at any point in the process, the claims advisor is unable to achieve the goal, one of the “Closed” options might instead be selected. Selecting a “Closed” option may effectively end the claims advisor process for the given opportunity. The information in the display 1200 might be saved by selection of a “Save” icon 1230.

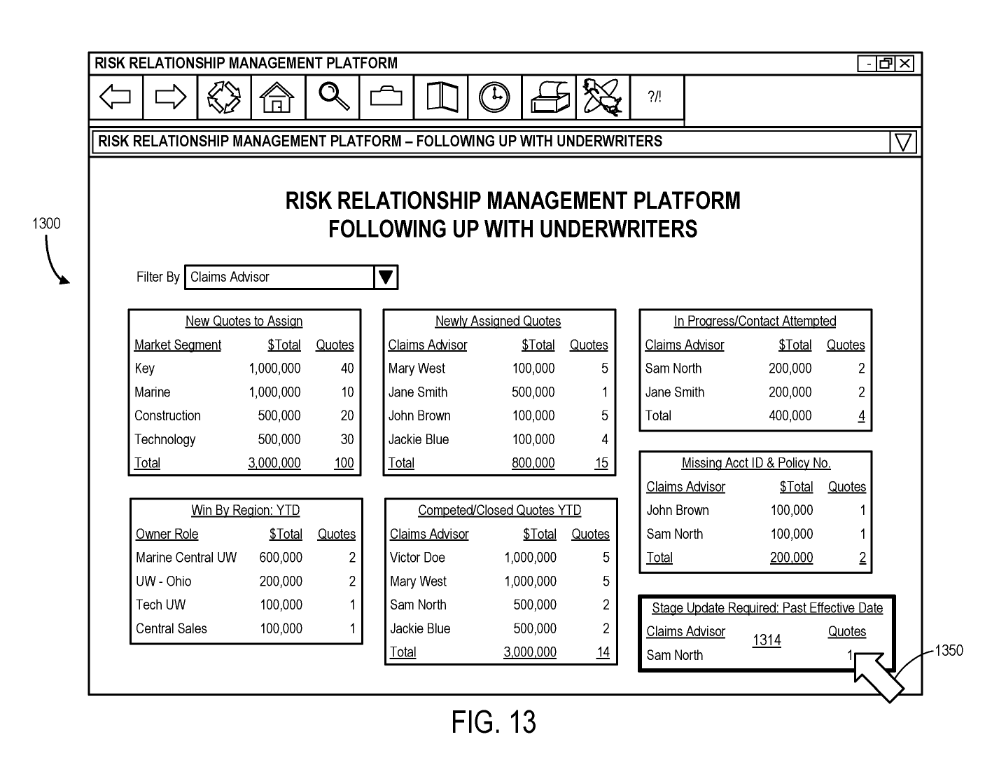

According to some embodiments, an interactive graphical user interface provided by the risk relationship management platform 350 includes an underwriter follow-up display. For example, a claims advisor might monitor a “Stage Update Required: Past Effective Date” portion 1314 on a dashboard display 1300 such as the one illustrated in FIG. 13 that lists all opportunities where the disposition is set to “Completed: Established Relationship,” the stage is still “2:Quoted,” but the policy effective date is still in the past. The claims advisor should drill into the full report by using a computer pointer 1350 to select the portion 1314, contact the underwriter listed on the report, and request that the underwriter update the stage for each opportunity to reflect the actual outcome (win or loss).

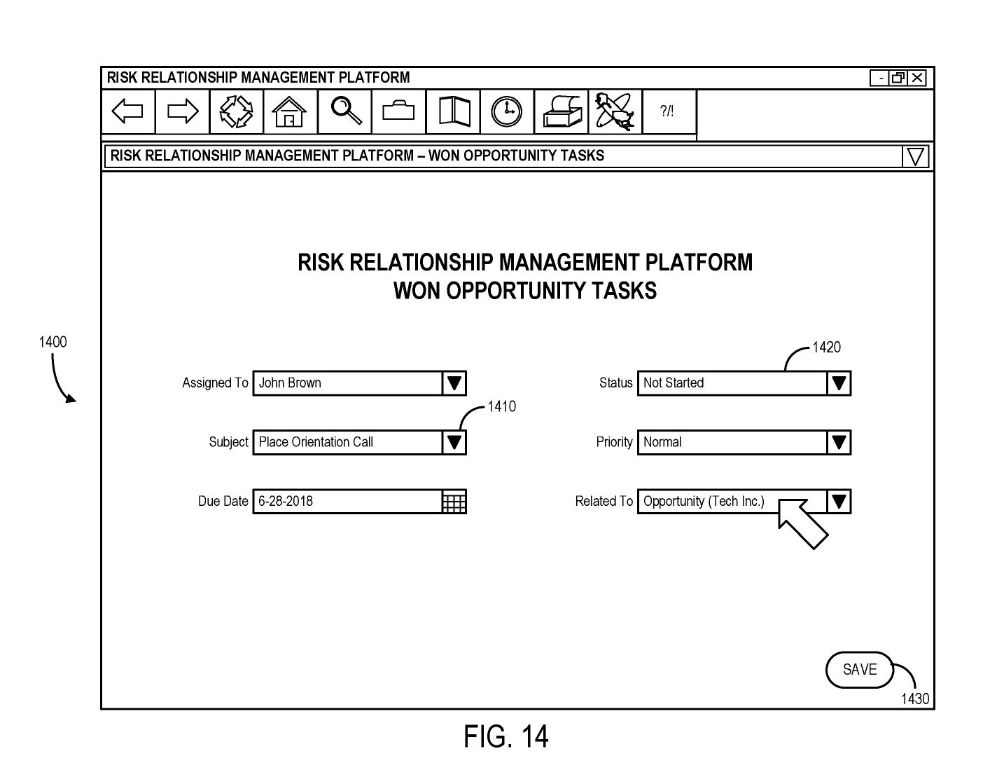

According to some embodiments, an interactive graphical user interface provided by the risk relationship management platform 350 includes a won opportunity task display. For example, FIG. 14 illustrates a won opportunity tasks display 1400 according to some embodiments. According to some embodiments, two task records are automatically created when a claims advisor establishes a relationship (that is, when the underwriter sets the stage description to “won”). The tasks (e.g., with subjects 1410 of “Place Orientation Call” and “Send Welcome Kit Email”) may be assigned to the claims advisor who worked on the opportunity and will have a status 1420 of “not started.” The tasks may also have automatically calculated due dates (e.g., the same day the opportunity was won), and any updates might be saved using a “Save” icon 1430.

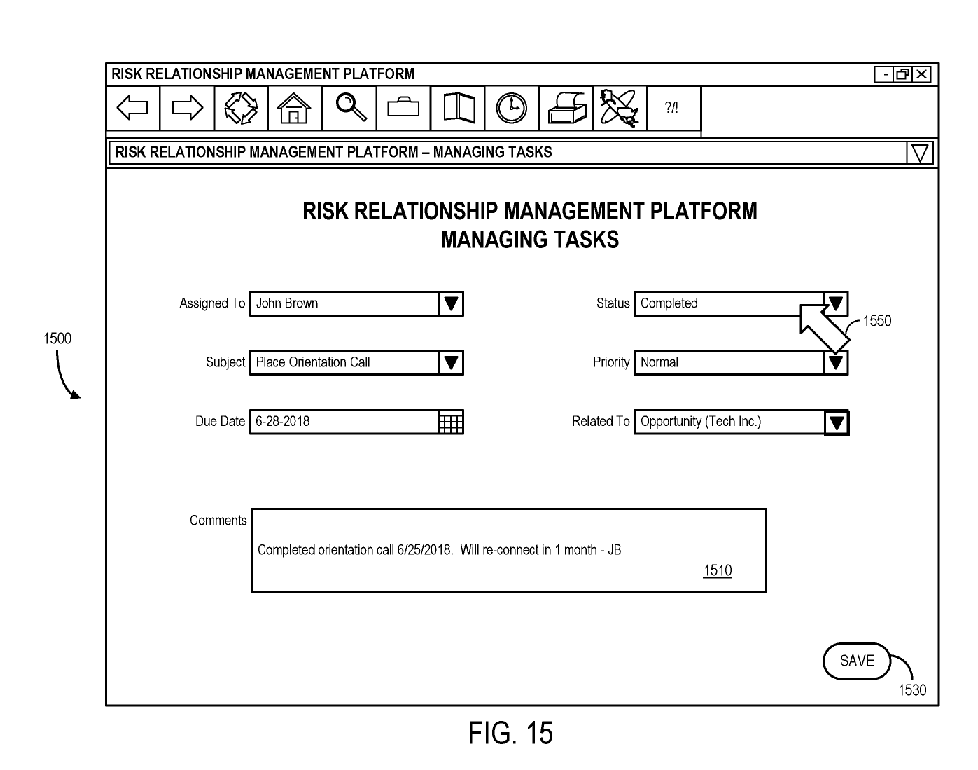

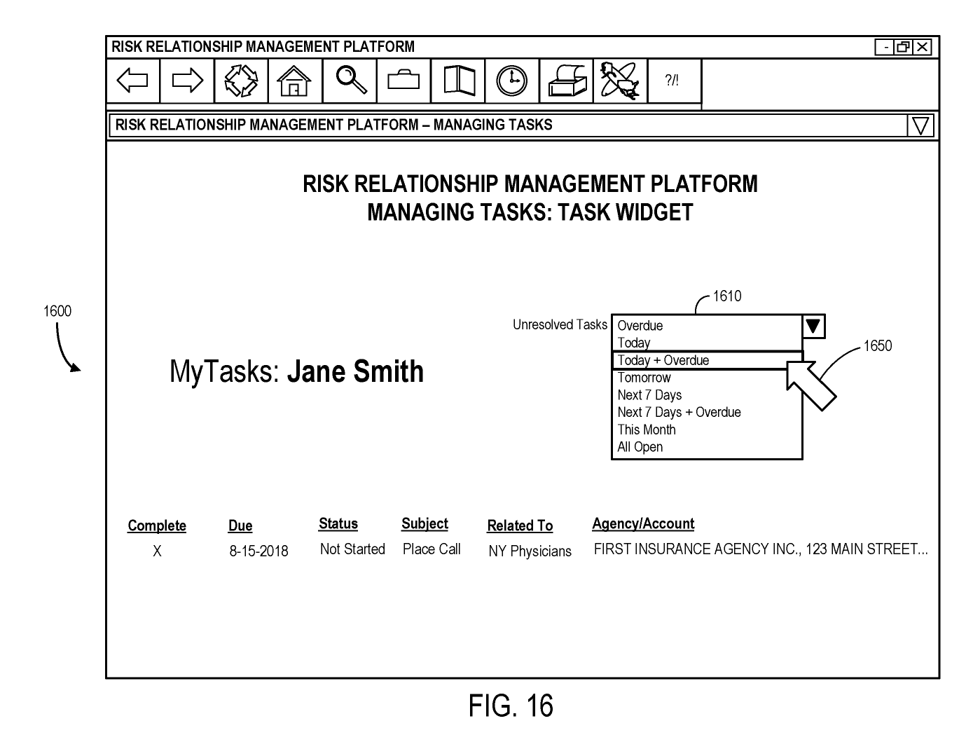

According to some embodiments, an interactive graphical user interface provided by the risk relationship management platform 350 includes a task management display. FIGS. 15 and 16 are associated with managing tasks displays in accordance with some embodiments. In particular, FIG. 1500 illustrates a managing task display 1500 where each task has a “due date” and a “status.” The claim advisor may have the responsibility of performing the activity that each task represents (e.g., to place the orientation telephone call and send a send a welcome kit) and then use a computer pointer 1550 to change the “status” field to “completed” to indicate that the activity as accomplished and/or to enter appropriate data into the comments portions 1510. The information in the display 1500 might be saved by selection of a “Save” icon 1530.

According to some embodiments, a claims advisor may have a “widget” (e.g., “MyTasks”) available. FIG. 16 illustrates a task widget display 1600 in accordance with some embodiments. The display 1600 has an “unresolved task” drop down menu 1610 and the advisor may use a computer pointer 1650 to select which tasks he or she would like displayed (e.g., those tasks due today, due within the next seven days, etc.). In this way, the claims advisor can manage tasks by utilizing different views. The display might include, for each task, an indication of whether the task is complete, a due date, a status, a subject, related information, and/or an agency or account associated with the task.

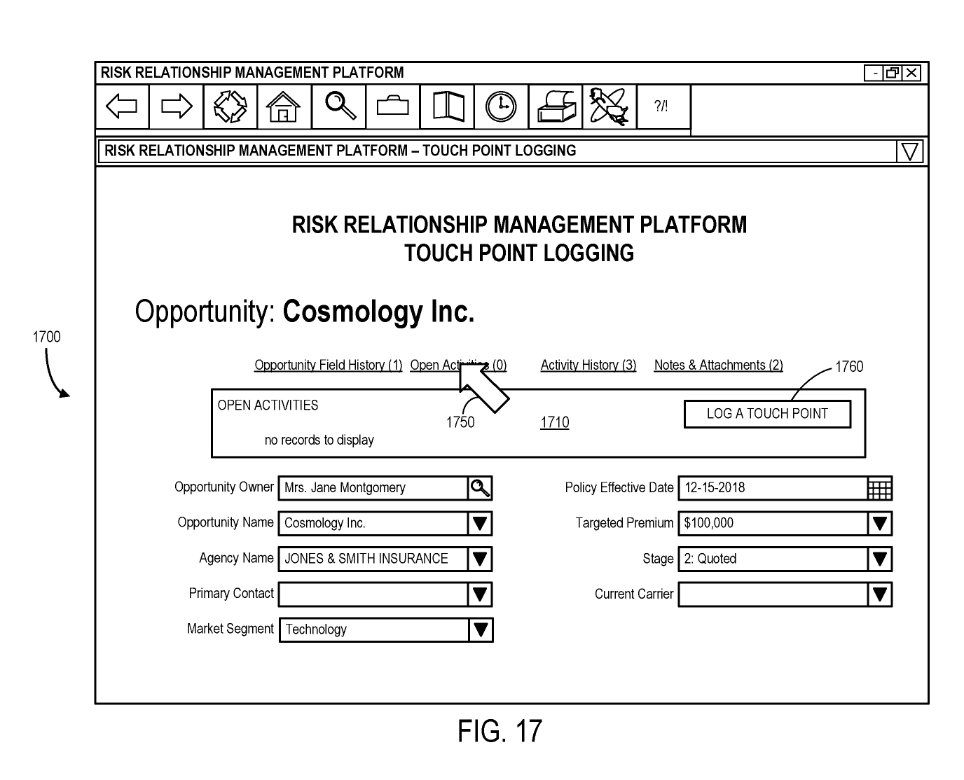

According to some embodiments, an interactive graphical user interface provided by the risk relationship management platform 350 includes a logging important touch points display. Note that a claims advisor might log important information each time a touch point is conducted with an insured, a underwriter, or other key players. As illustrated by the display 1700 of FIG. 17, to log a touch point, an advisor may navigate to the opportunity record, hover a computer pointer 1750 over an “Open Activities” link to view an open activities list 1710 and select a “Log a Touch Point” icon” 1760. A form might then be presented to the claims advisor allowing him or her to enter further details about the activity (e.g., when the activity was performed, the result of the activity, etc.).

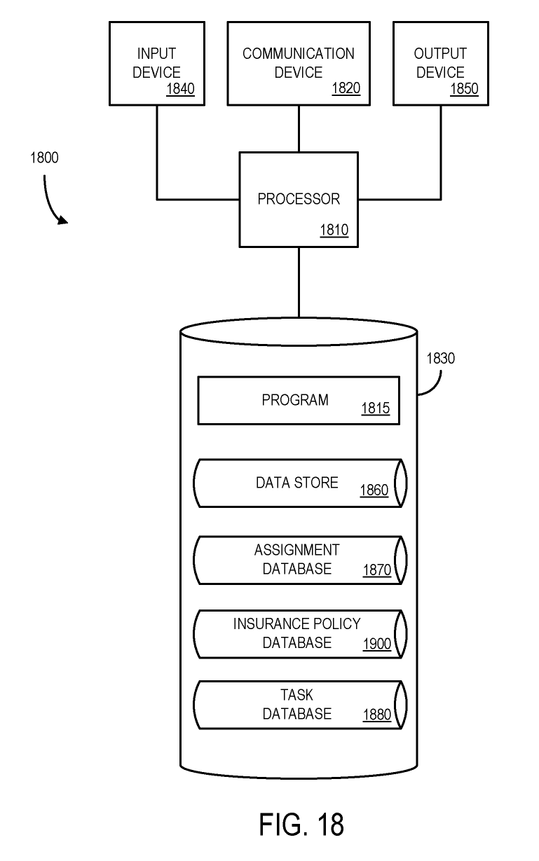

The embodiments described herein may be implemented using any number of different hardware configurations. For example, FIG. 18 illustrates a risk relationship management platform 1800 that may be, for example, associated with the systems 100, 300 of FIGS. 1 and 3, respectively. The risk relationship management platform 1800 comprises a processor 1810, such as one or more commercially available Central Processing Units (“CPUs”) in the form of one-chip microprocessors, coupled to a communication device 1820 configured to communicate via a communication network (not shown in FIG. 18). The communication device 1820 may be used to communicate, for example, with one or more remote assignment manager terminals, relationship handler terminals, external entity terminals, and/or or other communication devices (e.g., PCs and smartphones). Note that communications exchanged via the communication device 1820 may utilize security features, such as those between a public internet user and an internal network of the insurance enterprise. The security features might be associated with, for example, web servers, firewalls, and/or PCI infrastructure. The back-end application computer server 1800 further includes an input device 1840 (e.g., a mouse and/or keyboard to enter information about insurance opportunities, contact with a potential insured, etc.) and an output device 1850 (e.g., to output reports regarding system administration, currently opportunity status, year-to-date performance, etc.).

The processor 1810 also communicates with a storage device 1830. The storage device 1830 may comprise any appropriate information storage device, including combinations of magnetic storage devices (e.g., a hard disk drive), optical storage devices, mobile telephones, and/or semiconductor memory devices. The storage device 1830 stores a program 1815 and/or a risk relationship management engine or application for controlling the processor 1810. The processor 1810 performs instructions of the program 1815, and thereby operates in accordance with any of the embodiments described herein. For example, the processor 1810 may access an assignment computer store containing assignment manager identifiers, each linked to internal relationship handler identifiers (each in turn linked relationship identifiers). The processor 1810 may also access a risk relationship computer store that contains electronic data records each representing a risk relationship, with each electronic data record including a relationship identifier and a set of relationship characteristic values including a priority value). The processor 1810 may retrieve a selected electronic data record and determine that the priority value is above a minimum threshold and below a maximum threshold value. The selected relationship identifier may then be assigned one of the internal assignment manager identifiers and linked relationship handler identifier. A set of tasks may be generated by the processor 1810 along with a scheduled task date. A display at a relationship handler terminal associated with the assigned relationship handler identifier may then facilitate performance of the set of tasks in accordance with the associated scheduled task dates.

The program 1815 may be stored in a compressed, uncompiled and/or encrypted format. The program 1815 may furthermore include other program elements, such as an operating system, a database management system, and/or device drivers used by the processor 1810 to interface with peripheral devices.

As used herein, information may be “received” by or “transmitted” to, for example: (i) the back-end application computer server 1800 from another device; or (ii) a software application or module within the back-end application computer server 1800 from another software application, module, or any other source.

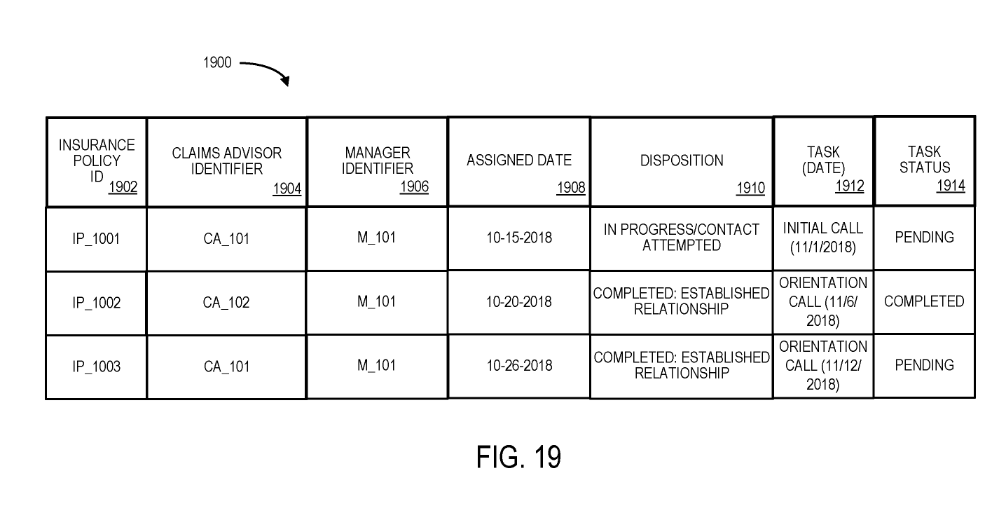

In some embodiments (such as shown in FIG. 18), the storage device 1830 further stores a computer data store 1860 (e.g., associated with underwrites, insured's, insurance agencies, etc.), an assignment database 1870, an insurance policy database 1900, and a task database 1880. An example of a database that might be used in connection with the risk relationship management platform 1800 will now be described in detail with respect to FIG. 19. Note that the database described herein is only an example, and additional and/or different information may be stored therein. Moreover, various databases might be split or combined in accordance with any of the embodiments described herein. For example, the computer data store 1860 and/or insurance policy database 1900 might be combined and/or linked to each other within the program 1815.

Referring to FIG. 19, a table is shown that represents the insurance policy database 1900 that may be stored at the risk relationship management platform 1800 according to some embodiments. The table may include, for example, entries associated with insurance policy opportunities and/or actual insurance policies issued by an insurer. The table may also define fields 1902, 1904, 1906, 1908, 1910, 1912, 194 for each of the entries. The fields 1902, 1904, 1906, 1908, 1910, 1912, 1914 may, according to some embodiments, specify: an insurance policy identifier 1902, a claims advisor identifier 1904, a manager identifier 1906, an assigned date 1908, a disposition 1910, a task (and associated task date) 1912, and a task status 1914. The insurance policy database 1900 may be created and updated, for example, based on information electrically received from a potential insured, a claims advisor, an underwriter, etc.

The insurance policy identifier 1902 may be, for example, a unique alphanumeric code identifying an insurance policy opportunity or an insurance policy that has already been issued. The claims advisor identifier 1904 and manager identifier 1906 may identify those parties that are responsible for handling that insurance policy. The assigned date 1908 might indicate when the claims advisor was assigned to the insurance policy and the disposition 1910 may describe the current status of the opportunity. The task (and associated task date) 1912 might indicate one or more steps that the claims advisor needs to take in connection with the insurance policy (and when those steps should be taken) and the task status 1914 might indicate, for example, that a task is “pending,” “in process,” or “completed.”

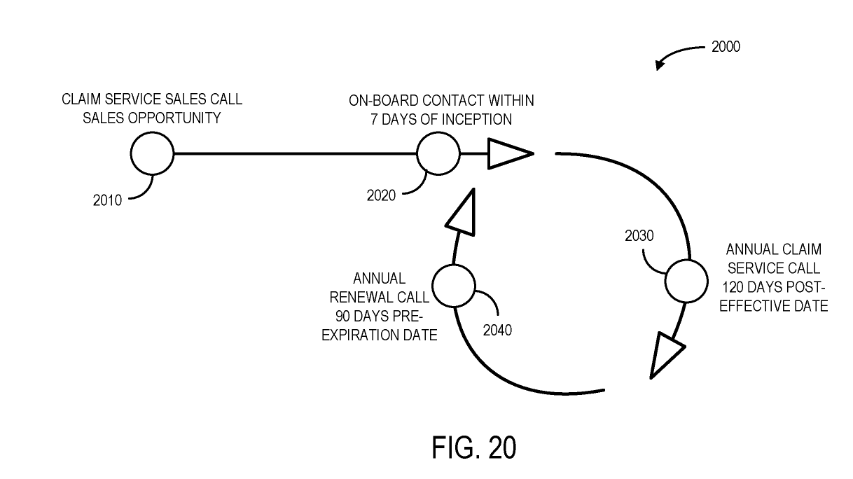

The tasks 1912 in the insurance policy database 1900 may be used to implement an overall workflow model to handle risk relationships with potential and actual insureds. For example, FIG. 20 is an example of a claims advisor model 2000 according to some embodiments. Note that, according to some embodiments, the system may assign the set of tasks to the assigned relationship handler (claims advisor), and the selected risk relationship (insurance policy) may be associated with a potential inception date of the insurance policy and a potential expiration date of the insurance policy. The set of tasks might include, for example: (i) an initial opportunity contact task, (ii) a pro-active status task scheduled a first pre-determined period of time after the potential inception date, and/or (iii) a potential renewal task scheduled a second pre-determined period of time prior to the potential expiration date. At 2010, a claims advisor may make an initial claim service sales telephone call associated with a potential insurance policy opportunity (e.g., an initial opportunity contact task). At 2020, the claims advisor may establish an on-board contact within a pre-determined period of time of inception of a newly sold insurance policy (e.g., within 7 days of inception). At 2030, the claims advisor may make a claim service telephone call a pre-determined period of time after inception of an insurance policy (e.g., a pro-active status task scheduled a first pre-determined period of time after the potential inception date, such as approximately 120 days after the effective date of the policy). According to some embodiments, the claims advisor will make an annual claim service call for existing insurance policies. At 2040, the claims advisor may make a renewal telephone call a pre-determined period of time before an insurance policy's expiration date (e.g., a potential renewal task scheduled a second pre-determined period of time prior to the potential expiration date, such as approximately 90 days before the insurance policy will expire). Note that the actions taken in connection with FIG. 20 might be “proactive” (e.g., the actions might be initiated by a claims advisor without being triggered by a particular event, such as the filing of an insurance claim). For example, even when no insurance claims have been filed, the claims advisor might point out to the customer (e.g., during the annual claim service call 2030) that such a situation is viewed favorably by the insurer and could result in an increased likelihood of renewal or other positive outcomes.

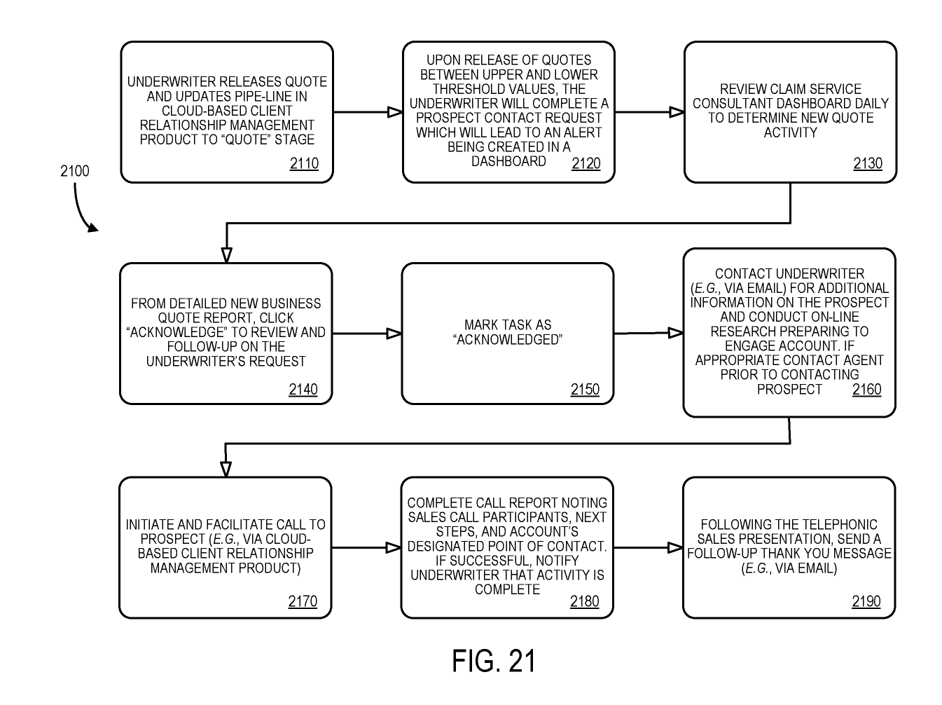

FIG. 21 illustrates a new business workflow 2100 in accordance with some embodiments. At 2110, an underwriter may release a quote and update a pipe-line in a cloud-based customer relationship management product to a “quote” stage. At 2120, the underwriter may—upon a release of quotes between upper and lower threshold values—complete a prospect contact request which will lead to an alert being created in a dashboard. At 2130, a claims manager or advisor may review a claim consultant dashboard (e.g., on a daily basis) to determine new quote activity. At 2140, the claim manager or advisor may (from a detailed new business quote report) click “acknowledge” to review and follow-up on the underwriter's request. At 2150, the task may be marked as “acknowledged.” At 2160, the underwriter may be contacted (e.g., via email) for additional information on the prospect and conduct online research preparing to engage account, and, if appropriate, contact the insurance agent prior to contacting a prospect. At 2170, the claims advisor may initiate and facilitate call to a prospect (e.g., via a cloud-based client relationship management product). At 2180, the claims advisor may complete a telephone call report noting the sales call participants, next steps, and the account's designated point of contact. If successful, the claims advisor may notify the underwriter that the activity is complete. At 2190, the claims advisor may send a thank you message (e.g., via email) following the telephonic sales presentation.

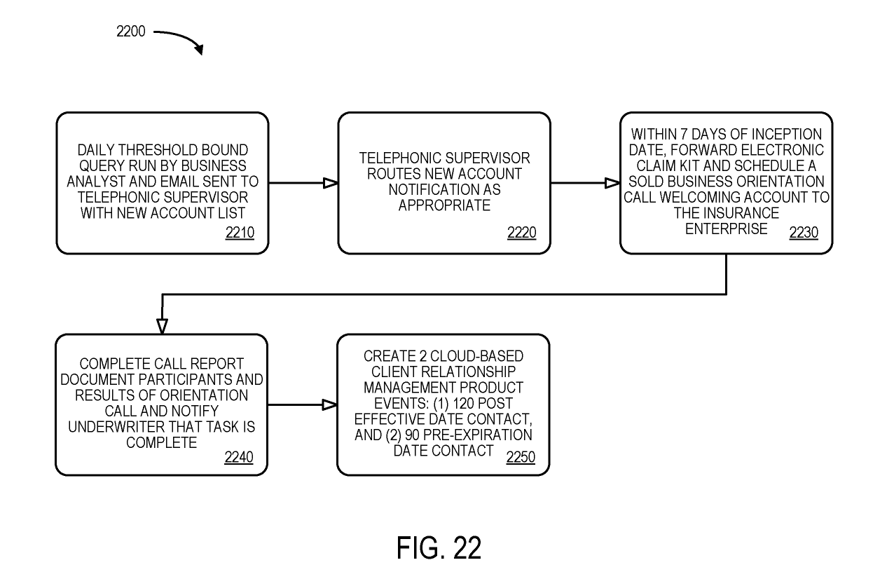

FIG. 22 illustrates a sold business orientation contact workflow 2200 according to some embodiments. At 2210, a daily threshold bound query may be run by a business analyst. An email may then be sent to a claims service consultant supervisor with a new account list. At 2220, the supervisor may route a new account notification as appropriate. At 2230, an electronic claim kit may be forwarded (e.g., within seven days of inception date). A sold business orientation call may also be scheduled to welcome the account to the insurance enterprise. At 2240, a call report may be completed to document participants and results of the orientation telephone call. The underwriter may then be notified that the task is complete. At 2250, two cloud-based client relationship management product events may be automatically created and scheduled: (i) a 120 day event post-effective date contact; and (ii) a 90 day pre-expiration date contact.

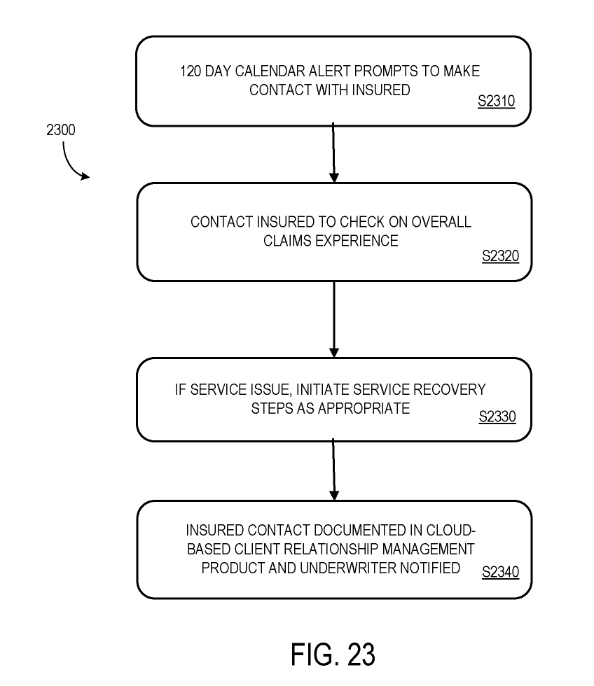

FIG. 23 illustrates a post-effective date workflow 2300 in accordance with some embodiments. At 2310, a 120 day calendar event may prompt a claims advisor to make contact with an insured. At 2320, the claims advisor may contact the insured to check about the overall claims experience. At 2330, service recovery steps may be initiated as appropriate if any service issues were identified at 2320. At 2340, contact with the insured is documented in a cloud-based client relationship management product and the underwriter may be notified that the task is complete.

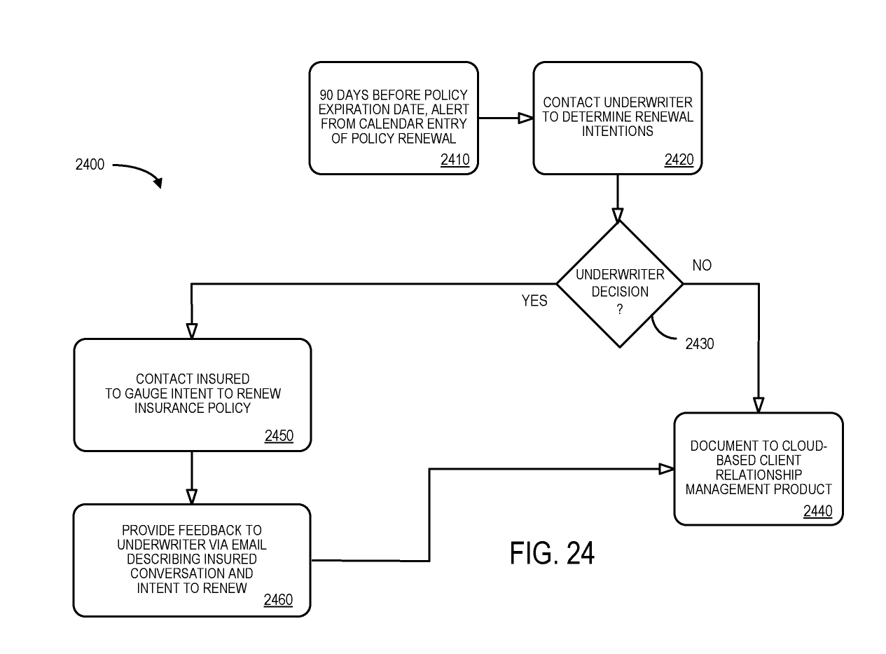

FIG. 24 illustrates a pre-expiration date contact workflow 2400 according to some embodiments. At 2410, an alert may be received from a calendar entry indicating that a policy renewal is about to occur (e.g., 90 days before the renewal). At 2420, a claims advisor may contact the insurance underwriter to determine the enterprise's renewal interest. If the underwriter decides that renewal is not appropriate at 2430, the decision is documented via a cloud-based client relationship management product at 2440. If the underwriter decides that renewal is appropriate at 2430, the claims advisor may contact the insured to gauge intent to renew the insurance policy at 2450. At 2460, the claims advisor may provide feedback to the underwriter via email describing the insured conversation and the intent to renew (if any). This information may then be documented via a cloud-based client relationship management product at 2440.

Thus, embodiments may accurately and efficiently facilitate processing of risk relationships for an enterprise, while allowing for flexibility and effectiveness when working with those relationships. Moreover, embodiments may help a claims advisor: support agents and underwriters in a sales process; facilitate the onboarding of new accounts (to help educate the insured about claim processes and contacts); be proactive with respect to serving accounts (to validate claim service delivery); facilitate claim service solutions; and/or process renewal calls to an account (to revisit service delivery and capabilities as appropriate).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

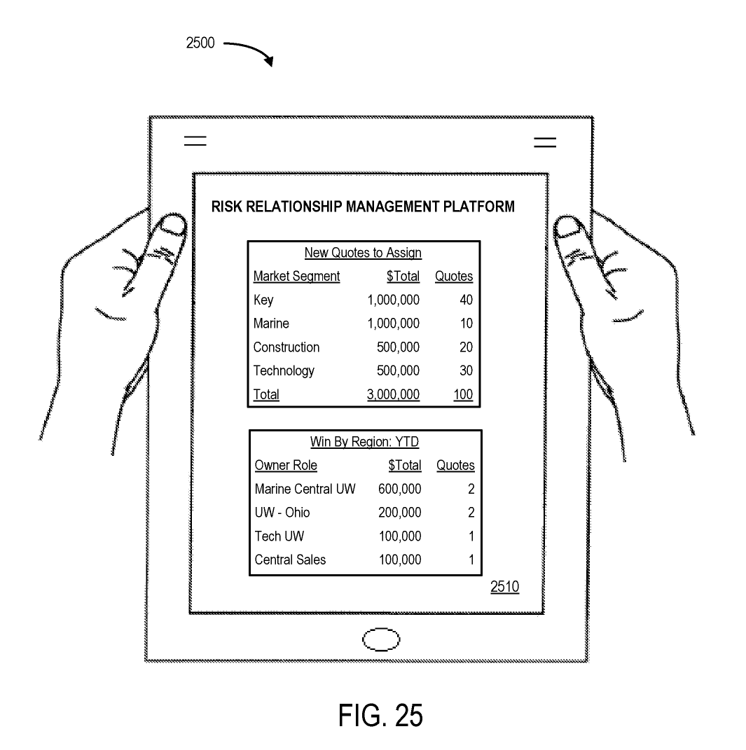

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of communication addresses, embodiments may instead be associated with other types of communications (e.g., chat implementations, web-based messaging, etc.). Similarly, although a certain number of opportunity tasks and stages were described in connection some embodiments described herein, other tasks and stages might be used instead (e.g., including tasks associated with multiple parties within an enterprise or entity). Still further, the displays and devices illustrated herein are only provided as examples, and embodiments may be associated with any other types of user interfaces. For example, FIG. 25 illustrates a handheld tablet computer 2500 displaying a risk relationship management platform display 2510 according to some embodiments. The risk relationship management platform display 2510 might include information about quotes and insurance opportunities that can be selected and/or modified by a user of the handheld computer 2500 (e.g., to see additional information, update tasks, etc.).

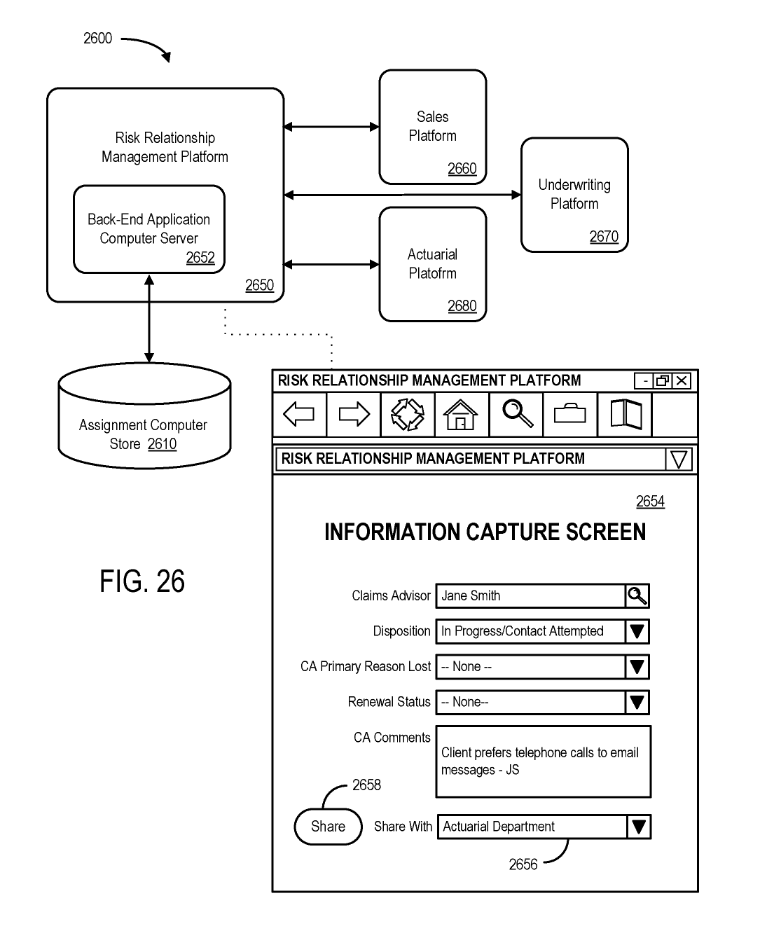

Although embodiments have been described with respect to specific types of information being shared between specific platforms, embodiments may share information in other ways. For example, FIG. 26 illustrates a system 2600 with a risk relationship management platform 2650 that accesses data from an assignment computer store 2610 to be shared with other platforms in accordance with some embodiments. In particular, a back-end application computer server 2652 may share insurance related information with a sales platform 2660, an underwriting platform 2670, and/or an actuarial platform 2680. This might be performed, for example, via an information capture screen display 2654 where a claims advisor might enter information and indicate that the information should be shared 2656 with one or more other platforms (e.g., by selection of a “Share” icon 2658). Such an approach might, for example, help capture customer preferences to facilitate the strategic marketing of a product. For example, the data provided by the risk relationship management platform 2650 might be shared to provide leads and/or referrals for other lines of insurance business (e.g., group benefits, workers' compensation, etc.).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to automatically facilitate processing of risk relationships for an enterprise, comprising:
(a) an assignment computer store containing a set of internal assignment manager identifiers, each internal assignment manager identifier being linked to a plurality of internal relationship handler identifiers, and each internal relationship handler identifier being linked to a plurality of relationship identifiers between the enterprise and entities;
(b) a risk relationship computer store containing a set of electronic data records each representing a risk relationship between the enterprise and an entity, each electronic data record including a relationship identifier and a set of relationship characteristic values with at least one characteristic value being a priority value for that risk relationship;
(c) an automated risk relationship management platform computer, coupled to the assignment computer store and the risk relationship computer store, and programmed to:
(i) retrieve a selected electronic data record from the risk relationship computer store,
(ii) determine that the priority value of the risk relationship represented by the selected electronic data record is both above a pre-determined minimum threshold priority value and below a pre-determined maximum threshold priority value,
(iii) responsive to said determination, arrange for the selected relationship identifier to be assigned to one of the internal assignment manager identifiers and linked relationship handler identifier in the assignment computer store,
(iv) automatically generate a set of tasks for the risk relationship associated with the selected electronic data record,
(v) automatically calculate a scheduled task date for each automatically generated task, and
(vi) assign the set of tasks to the assigned relationship handler, wherein the selected risk relationship is associated with a potential inception date of the risk relationship and a potential expiration date of the risk relationship, the set of tasks including:
an initial opportunity contact task,
a pro-active status task scheduled a first pre-determined period of time after the potential inception date, and
a potential renewal task scheduled a second pre-determined period of time prior to the potential expiration date; and
(d) a communication port coupled to the risk relationship management platform to facilitate an exchange of electronic messages, via a distributed communication network, to present an interactive user interface at a remote relationship handler terminal associated with the assigned relationship handler identifier to facilitate performance of the generated set of tasks in accordance with the associated scheduled task dates.

2. The system of claim 1, wherein at least one risk relationship is associated with a potential future risk relationship between the enterprise and an entity.

3. The system of claim 1, wherein at least one risk relationship is associated with an existing risk relationship between the enterprise and an entity.

4. The system of claim 1, wherein the interactive user interface display at the remote relationship handler terminal automatically facilitates a communication link with a remote external entity terminal.

5. The system of claim 4, wherein the communication link is associated with at least one of: (i) a telephone call, (ii) a web chat, (iii) a video link, (iv) an electronic mail message, and (v) a postal mail message generated via a distribution center.

6. The system of claim 1, wherein the risk relationships are insurance policies, the enterprise is an insurer, the internal relationship handler identifiers are claims advisor identifiers, and the priority values are insurance premiums.

7. The system of claim 6, wherein the communication port is further to communicate via a cloud-based client relationship management product.

8. The system of claim 6, wherein the selected electronic data record is further evaluated, prior to being assigned, based on at least one of: (i) a type of insurance, (ii) information from an underwriter, (iii) a type of industry, (iv) an opportunity age, (v) an opportunity likelihood of success, (vi) an entity priority, and (vii) an insurer office.

9. The system of claim 6, wherein the interactive graphical user interface further includes at least one of: (i) a claims manager workflow, (ii) a claims advisor workflow, (iii) an underwriter follow-up display, (iv) a won opportunity task display, (v) a task management display, and (vi) a logging important touch points display.

10. The system of claim 6, wherein the interactive graphical user interface displays at least two of: (i) new quotes to assign, (ii) opportunity wins by region, (iii) newly assigned quotes, (iv) completed and closed quotes, (v) in progress quotes and quotes for which a contact hast been attempted, and (vi) quotes that missing account identifiers or insurance policy numbers.

11. The system of claim 6, wherein the interactive graphical user interface displays at least two of: (i) a claims advisor name, (ii) a disposition, (iii) a primary reason why an opportunity was lost, (iv) a renewal status, (v) claims advisor comments, (vi) an insured's primary contact, (vii) an insured's primary phone number, (viii) an insured's primary email address, (ix) a date a claims advisor was assigned, and (x) a date a claims advisor completed or closed the opportunity.

12. The system of claim 6, wherein at least one of the tasks is associated with: (i) an initial claim service sales call associated with a potential insurance policy opportunity, (ii) an on-board contact within a pre-determined period of time of inception of a newly sold insurance policy, (iii) a claim service call a pre-determined period of time after inception of an insurance policy, (iv) an annual claim service call, and (v) a renewal call a pre-determined period of time before an insurance policy's expiration date.

13. The system of claim 1, wherein at least one relationship identifier is linked to a plurality of internal relationship handlers in the assignment computer store.

14. A computerized method to automatically facilitate processing of risk relationships for an enterprise, comprising:
managing an assignment computer store containing a set of internal assignment manager identifiers, each internal assignment manager identifier being linked to a plurality of internal relationship handler identifiers, and each internal relationship handler being linked to a plurality of relationship identifiers between the enterprise and entities;
managing a risk relationship computer store containing a set of electronic data records each representing a risk relationship between the enterprise and an entity, each electronic data record including a relationship identifier and a set of relationship characteristic values with at least one characteristic value being a priority value for that risk relationship;
retrieving, via an automated risk relationship management platform computer, a selected electronic data record from the risk relationship computer store;
determining, by the automated risk relationship management platform computer, that the priority value of the risk relationship represented by the selected electronic data record is both above a pre-determined minimum threshold priority value and below a pre-determined maximum threshold priority value;
responsive to said determination, arranging for the selected relationship identifier to be assigned to one of the internal assignment manager identifiers and linked relationship handler identifier in the assignment computer store;
generating a set of tasks for the risk relationship associated with the selected electronic data record;
calculating a scheduled task date for each automatically generated task;
assigning the set of tasks to the assigned relationship handler, wherein the selected risk relationship is associated with a potential inception date of the risk relationship and a potential expiration date of the risk relationship, the set of tasks including:
an initial opportunity contact task,
a pro-active status task scheduled a first pre-determined period of time after the potential inception date, and
a potential renewal task scheduled a second pre-determined period of time prior to the potential expiration date; and
exchanging electronic messages, via a distributed communication network, to present an interactive user interface at a remote relationship handler terminal associated with the assigned relationship handler identifier to facilitate performance of the generated set of tasks in accordance with the associated scheduled task dates.

15. The method of claim 14, wherein at least one risk relationship is associated with at least one of: (i) a potential future risk relationship between the enterprise and an entity, and (ii) an existing risk relationship between the enterprise and an entity.

16. The method of claim 14, wherein the interactive user interface display at the remote relationship handler terminal automatically facilitates a communication link with a remote external entity terminal, wherein the communication link is associated with at least one of: (i) a telephone call, (ii) a web chat, (iii) a video link, (iv) an electronic mail message, and (v) a postal mail message generated via a distribution center.

17. The method of claim 1, wherein the risk relationships are insurance policies, the enterprise is an insurer, the internal relationship handler identifiers are claims advisor identifiers, and the priority values are insurance premiums.

18. The method of claim 17, wherein at least one of the tasks is associated with: (i) an initial claim service sales call associated with a potential insurance policy opportunity, (ii) an on-board contact within a pre-determined period of time of inception of a newly sold insurance policy, (iii) a claim service call a pre-determined period of time after inception of an insurance policy, (iv) an annual claim service call, and (v) a renewal call a pre-determined period of time before an insurance policy's expiration date.

19. A system to automatically facilitate processing of insurance policies for an insurer, comprising:
(a) an assignment computer store containing a set of manager identifiers, each manager identifier being linked to a plurality of claims advisor identifiers, and each claims advisor identifier being linked a plurality of policy identifiers between the insurer and insureds;
(b) an insurance policy computer store containing a set of electronic data records each representing an insurance policy between the insurer and an insured, each electronic data record including an insurance policy identifier and a set of relationship characteristic values with at least one characteristic value being a premium value for that insurance policy;
(c) an automated opportunity management platform computer, coupled to the assignment computer store and the insurance policy computer store, and programmed to:
(i) retrieve a selected electronic data record from the insurance policy computer store,
(ii) determine that the premium of the insurance policy represented by the selected electronic data record is both above a first value and below a second value,
(iii) responsive to said determination, arrange for the selected insurance policy identifier to be assigned to one of the manager identifiers and linked claims advisor identifier in the assignment computer store,
(iv) automatically generate a set of tasks for the insurance policy associated with the selected electronic data record, and
(v) automatically calculate a scheduled task date for each automatically generated task;
(d) an interactive graphical user interface platform to assign and display information about the set of tasks to the assigned claims advisor, wherein the selected insurance policy is associated with a potential inception date of the insurance policy and a potential expiration date of the insurance policy, the display including:
a graphical display of an initial opportunity contact task,
a graphical display of a pro-active status task scheduled a first pre-determined period of time after the potential inception date, and
a graphical display of a potential renewal task scheduled a second pre-determined period of time prior to the potential expiration date; and
(e) a communication port coupled to the opportunity management platform to facilitate an exchange of electronic messages, via a cloud-based client relationship management product, to present the interactive graphical user interface at a remote claims advisor terminal to facilitate performance of the generated set of tasks in accordance with the associated scheduled task dates.

20. The system of claim 19, wherein at least one insurance policy is associated with at least one of: (i) potential future insurance policy between the insurer and an insured, and (ii) an existing insurance policy between the insurer and insured.
